(19) United States
(12) Patent Application Publication
(10) Pub. No.: US 2009/0013736 A1
(43) Pub. Date: Jan. 15, 2009

(54) Electronic lock

(76) Inventor: Robert C. Voosen, Randolph, MA (US)

Correspondence Address: STEVEN N. FOX, ESQ., P.O. BOX 251, CANTON, MA, 02021, US

(21) Appl. No.: 12/218,039

(22) Filed: Jul. 9, 2008

Related U.S. Application Data
(60) Provisional application No. 60/958,805, filed on Jul. 9, 2007.

(51) Int. Cl. E05B 47/00

(52) U.S. Cl. 70/277

(57) ABSTRACT

Disclosed is an electronic lock. In one embodiment, the electronic lock comprises a body, a barrel having a slot, a pin disposed in the slot, a blocking member disposed in the body to prevent movement of the pin, and an electro-mechanical device. Activation of the electro-mechanical device causes the blocking member to be moved clear of the pin and movement of the barrel causes the pin to be moved out of the slot.

### CROSS-REFERENCE TO RELATED APPLICATIONS

This applications claims the benefit of and priority to U.S. Provisional Patent Application Ser. No. 60/958,805 filed on Jul. 9, 2007, now pending, which is hereby incorporated by reference in its entirety into this specification.

### BACKGROUND OF THE INVENTION

The present invention relates to electronic versions of mechanical locks. Typically, a key operated lock whereby a key like device is inserted and turned or pushed to operate the lock as if it were a mechanical device. This type of lock is part of a system with electronic apparatus to identify the key and the lock and to provide power for the operation of electro-mechanical mechanisms. The electronic apparatus determines if the key is allowed to open or unlock the lock. It can also be used in a locking mechanism operated by a handle instead of a key but controlled by the electronic apparatus.

Electronic locks are becoming more common. As the complexity and cost come down electronic locks may well replace mechanical locks in many applications. The features and value of electronic locks make them more practical and efficient in some industries now but still have issues with strength and security compared to mechanical locks. Creating a robust electronic lock while keeping it within the outline of a standard mechanical lock type is one challenge and keeping it easy to use is another challenge. Ergonomics in use and simplification of maintenance are other considerations that are important to proliferate the electronic lock into more applications and market tiers.

Electro-mechanical mechanisms in locks provide the means for electronic devices to control the mechanical action of the lock: either allowing the lock to open or prevent it from opening. These electro-mechanical mechanisms require power to operate. The less power required the more actuations can be performed within the battery capacity or allow a smaller battery within the key (for battery operated versions) or the smaller the conductors or greater wire length run (for wired versions).

Moving pins or other mechanical parts that have sufficient strength to keep the lock secure or to drive cams or latches within the lock can require considerable relative power. The size constraints imposed by fitting the electronic and electro-mechanical parts within a standard lock body also impose limitations on the shape and power of the electro-mechanical device. Smaller devices often either lack the power to move appropriate components or are too costly to allow their use in the majority of applications.

Another consideration is that this mechanism must also be designed in such a way that it cannot be easily defeated by external means such as inertia of the lock induced by moving or striking the lock. In the case of fixed locks on doors or cabinets this is controlled fairly simply but in portable applications, such as padlocks, preventing this means of defeat can be quite intricate. These anti-inertia devices often also add to the load requirement of the electro-mechanical device.

The largest effort and use of power in any mechanism is often overcoming the initial momentum of the parts, including the parts of the electro-mechanical device itself. Reducing the mass of these parts and/or eliminating or staggering the initial loading of the electro-mechanical device drastically changes the size and power requirements of the device.

Most electronic locks use a solenoid to control a device to either block a lock from operating or to engage the latch to allow a handle or key to operate it. This block must be strong enough to secure the lock. Solenoids are notoriously inefficient in converting electrical power to mechanical movement. They also require provision for the large inrush current when first powered and protection from the induced reverse current when the internal electrical field collapses when power is removed. The former usually adds a relatively large capacitor to the circuit which must be charged prior to activating the solenoid.

### SUMMARY OF THE INVENTION

The present invention transfers the majority of power required to mechanically move the blocking or engaging mechanism directly to the user, incorporating it into the normal action of turning the key. The invention also removes initial load from the electro-mechanical control device so that smaller more power efficient devices can be used within the lock.

The invention transfers that power requirement from the electrical circuit to the manual force used to operate the lock mechanically. The hand turning the key provides the power to move internal parts. The electro-mechanical device merely controls where and how parts move which requires much less power.

By reducing the load, the invention also allows the use of many alternative electro-mechanical devices that would be unsuitable in traditional mechanisms since it imposes no start up loads and no parasitic loads, and requires very little movement of the control or steering device. Since the load on the device is defined within the mechanism, regardless of outside force applied, unusual approaches to controlling movement, such as electrically changing fluid viscosity, may be incorporated into lock designs providing lower power requirements and/or lower costs.

The invention comprises a device that is actuated by the movement of part of the lock that is turned or pushed by the key user when attempting to open a lock plus an electro-mechanical interface (device?) that directs the device to restrict or allow opening based on input from an electronic access system.

The invention uses a small movement in the lock supplied by the lock user to provide force to propel the blocking or engaging parts. The path that these parts follow is determined by a steering mechanism controlled by a very small electro-mechanical device. Since the steering mechanism requires only a fraction of the power requirement of moving the blocking or engaging parts considerable power is saved.

### BRIEF DESCRIPTION OF THE DRAWINGS

The following detailed description will be more fully understood with reference to the accompanying drawings, in which:

FIG. 1 is a cross-section view of the electronic lock according to the present invention shown in a normal locked state and a key;

FIG. 2 is a plan view of the rear face of the barrel without the latch cam and the body of the lock with the bayonet slots top and bottom. This shows the barrel in the normal at rest state. FIG. 1A also shows the face of the key that mates to the barrel;

FIG. 3 shows the position of the components in the lock as it is operated by the key without the solenoid activated;

FIG. 4 shows rotation of the rear face of the barrel by the key. The locking pin will stop the rotation at this point if the solenoid is not activated;

FIG. 5 shows the position of the components in the lock as it is operated by the key with the solenoid activated;

FIG. 6 shows further rotation of the barrel and a rear view of the barrel as the locking pin clears the cutout;

FIG. 7 shows the lock components in the unlocked state. The barrel is turned 90 degrees and the cam on the barrel has retracted the latch;

FIG. 8 shows the rear face of the barrel rotated 90 degrees;

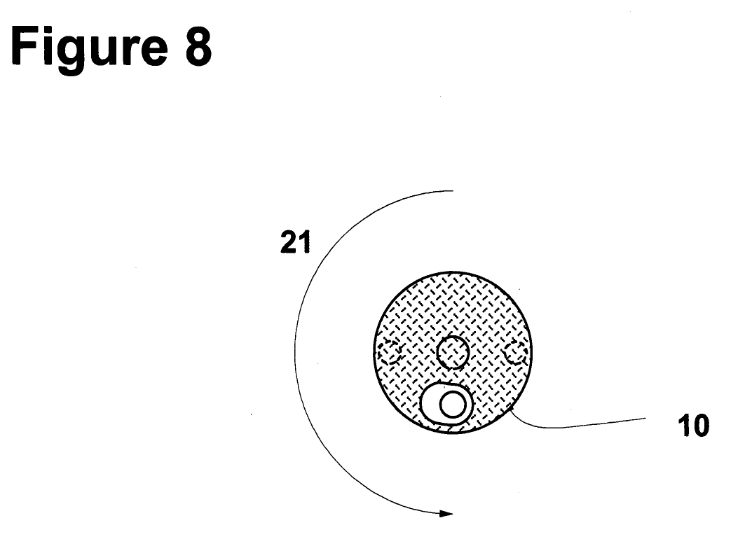

FIG. 9 shows a single weight motor version of an electro-mechanical blocking device. The upper illustration is the motor at rest. The lower illustration shows the relative position of the weight when the motor is spinning;

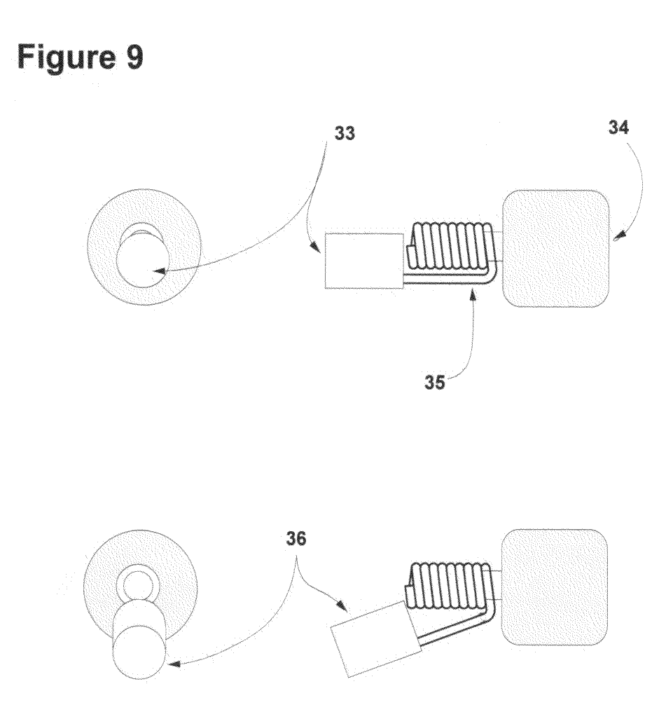

FIG. 10 shows a dual weight blocking mechanism attached to a motor. The upper right illustration shows the blocking pins position with the motor at rest. The lower right illustration shows the relative position of the blocking pins with the motor spinning; and

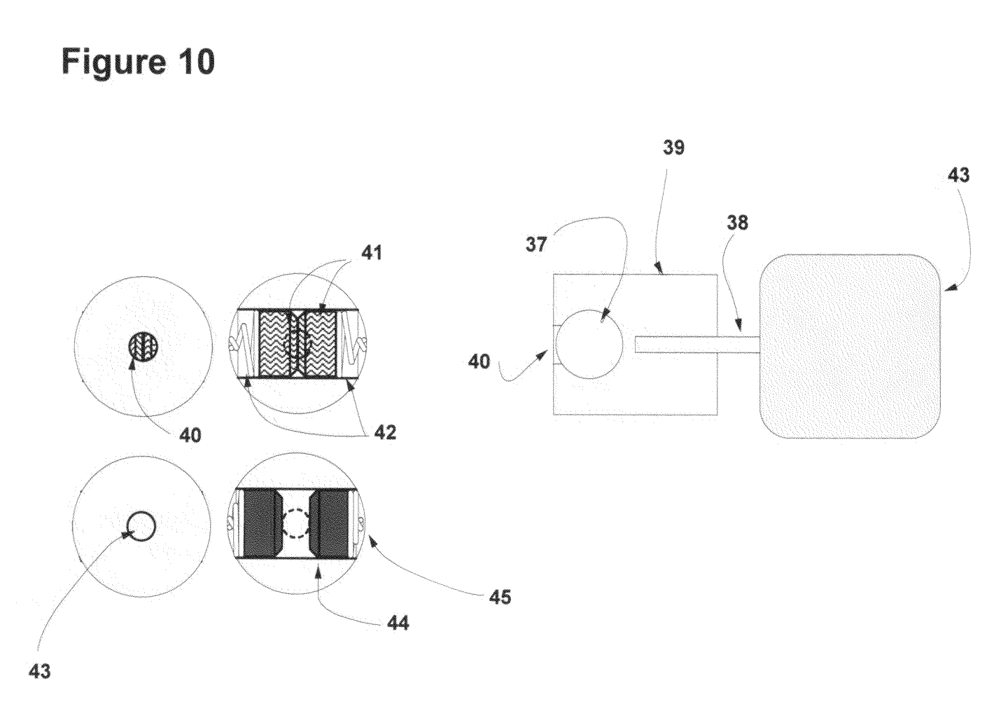

FIG. 11 shows a dual blocking pin motor mechanism inside the lock.

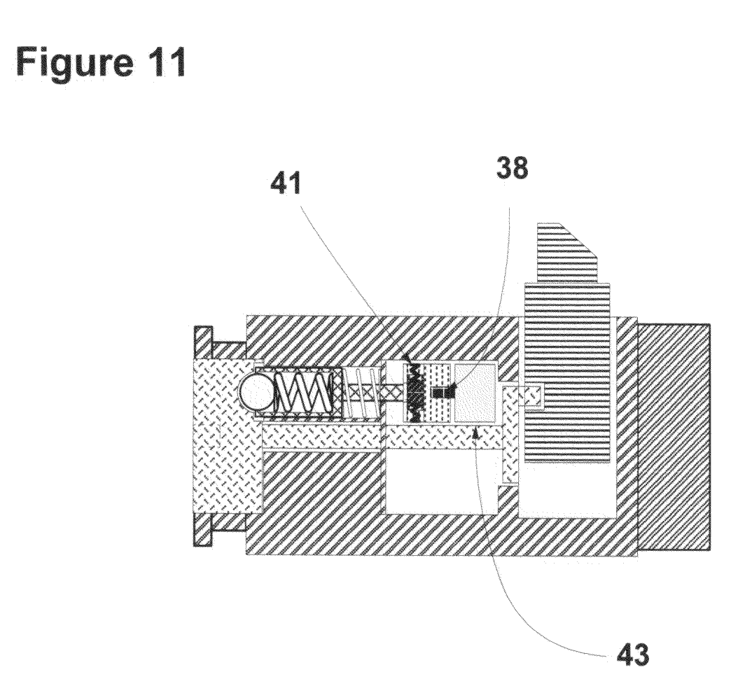

### DESCRIPTION OF THE INVENTION

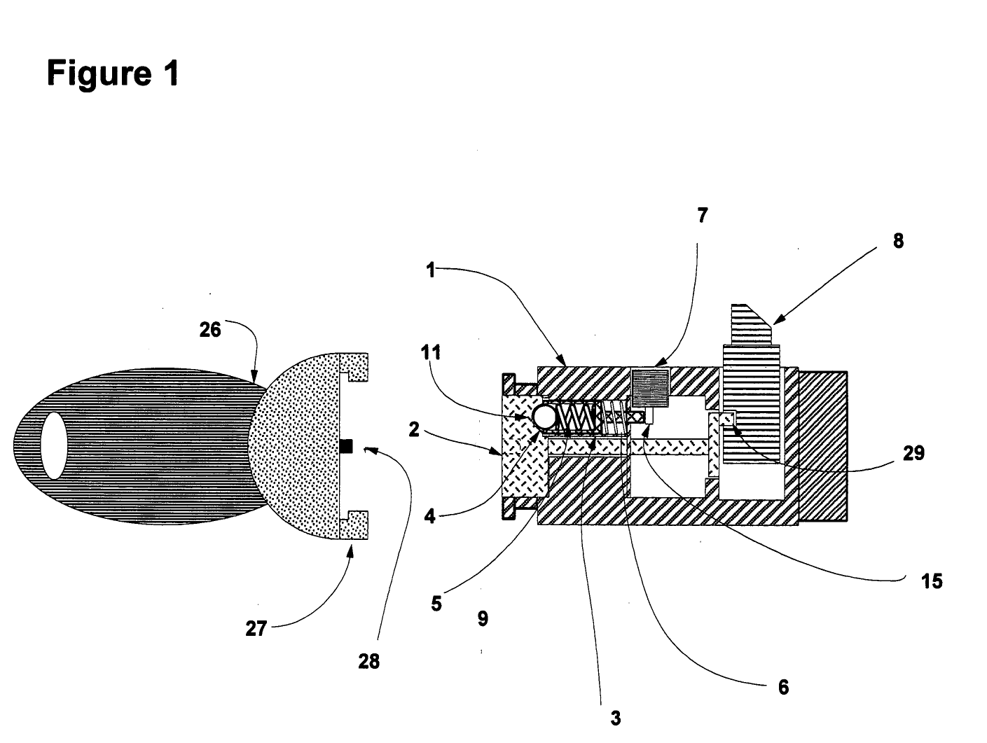

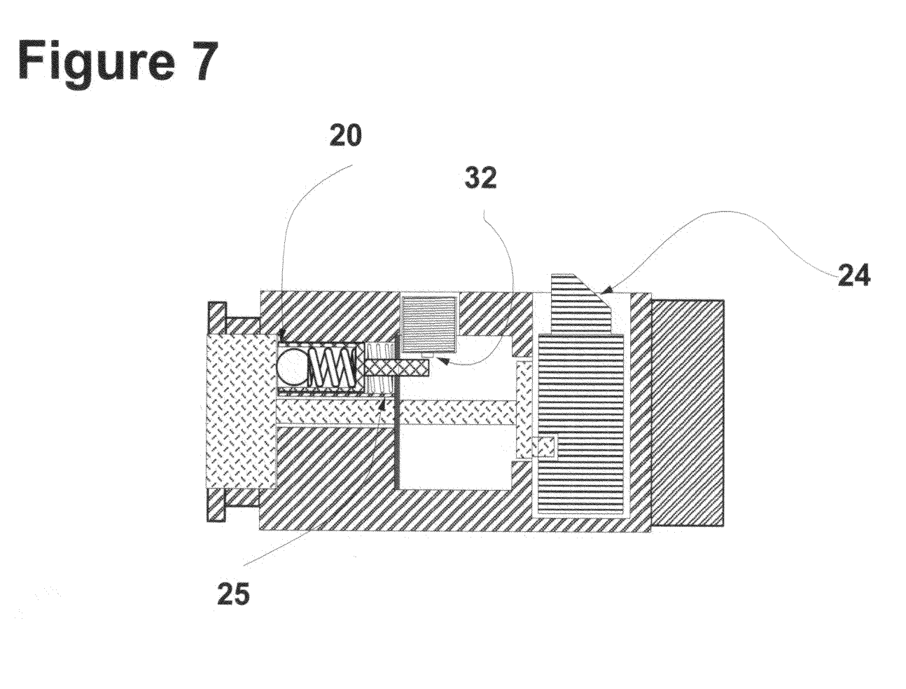

Referring to FIGS. 1-7, the present invention is an electronic lock generally comprising a lock body (1), a front barrel (2), a locking pin (3), a ball bearing (4), a thrust spring, (5) a return spring (6), a solenoid (7), a latch (8), and a key (26). The front barrel (2) is turned by the key (26) by two drive pins (28) while the key is held on the lock body with a bayonet mechanism (27). The front barrel drives an attached cam (29) that retracts the latch (8) which opens the lock. The locking pin (3) prevents the barrel from turning unless the locking pin moves back and clears the cutout (9) in the back of the barrel (10).

The end of the locking pin (3) against the back of the barrel (2) is hollow and contains the ball bearing (4) and thrust spring (5). When at rest, the end of the locking pin (3) is positioned in the cutout of the barrel (2) at a depth that will restrict the barrel (2) when turned to the end of the cutout. The ball bearing (4) protrudes from the hollow portion of the locking pin (3) by the depth of the cutout in the barrel (2) into a recess or detent (11) within the cutout on the back of the barrel (2).

The cutout (9) in the back of the barrel view (12) allows the key to turn the barrel about 15 degrees (13) until the locking pin engages the end of the cutout (14) and prevents further movement.

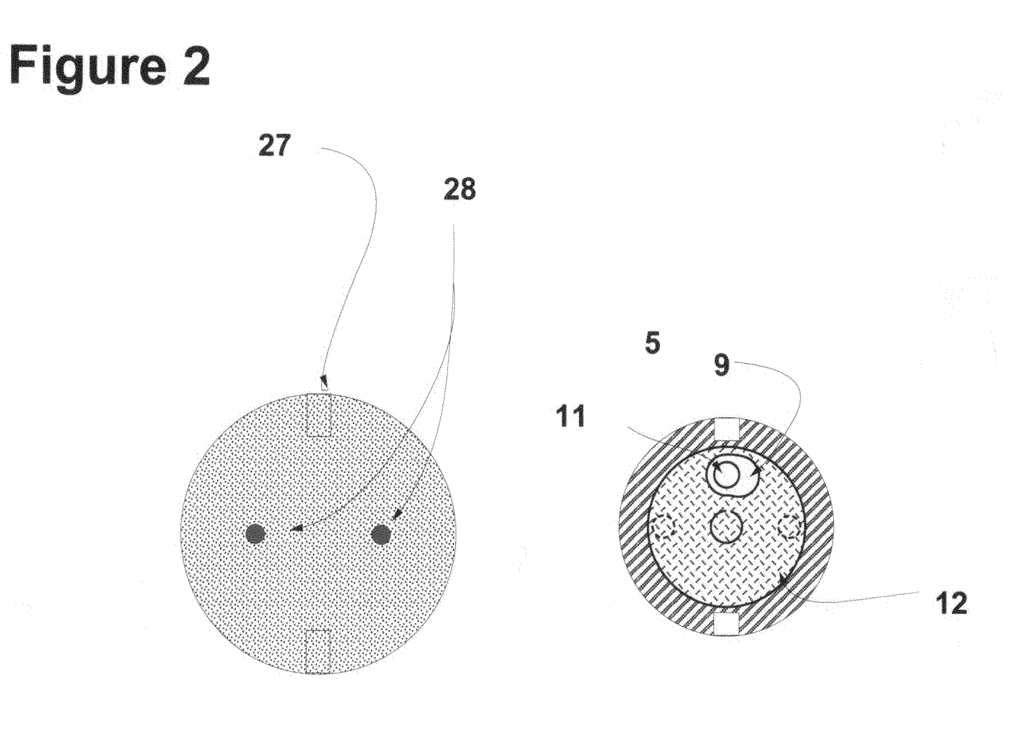

When the barrel is turned with the key (FIG. 2) it pushes the ball bearing out of the detent since the locking pin is held stationary by the lock body relative to the movement of the barrel. As the ball bearing moves out of the detent as the barrel turns (17), it pushes on the thrust spring (5) which pushes on the locking pin (3). If the locking pin (3) is blocked by the electro-mechanical device (16) then the thrust spring (18) will compress and the locking pin will stay in the cutout (9) and block the barrel from rotating further once it comes to the end of the cutout (14).

The rear end of the locking pin interacts with the electro-mechanical device controlled by an electronic circuit. The locking pin is either allowed to move (16) toward the back of the lock or prevented from moving (15) by the electro-mechanical device. The electro-mechanical device can be very small and low power because it only needs to overcome the force of the thrust spring that is driven by the ball bearing. No matter how much force is put on the lock or barrel the electro-mechanical device needs to apply to apply enough stopping force to compress the thrust spring (18). In the illustrated embodiment, a solenoid (7) is used as the electro-mechanical device. In this embodiment, the at rest state of the solenoid armature blocks the locking pin and keeps the lock in the locked state.

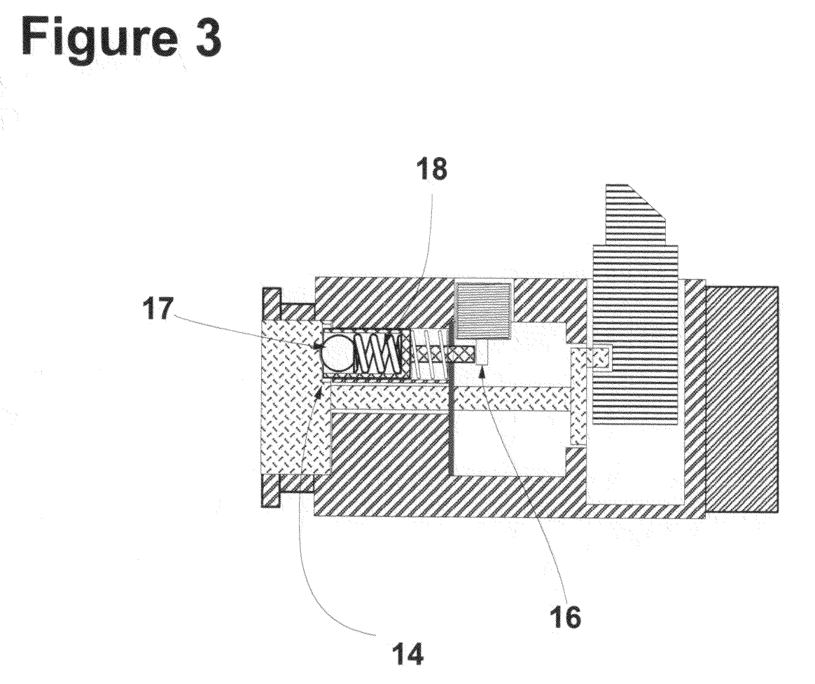

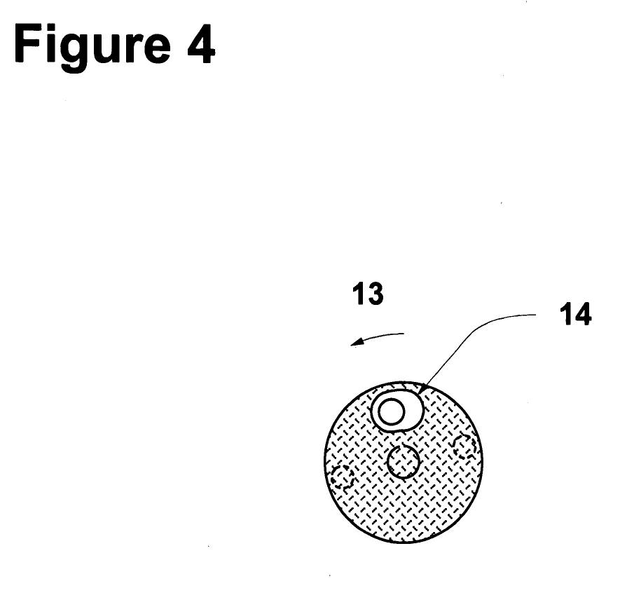

If the electronic circuit allows the lock to open it will power the electro-mechanical device. The illustration shows the solenoid armature retracted (32) whereby the locking pin is not blocked (FIGS. 3 and 4) by the electro-mechanical device (30) then the ball bearing pushes on the thrust spring which pushes which pushes the locking pin toward the back of the lock (19). As the barrel continues to rotate (21) the locking pin has been pushed outside the cutout depth (31) so it does not prevent the further rotation of the barrel (20). The barrel can then rotate far enough to retract the latch thereby unlocking the lock (24).

The rearward movement of the locking pin compresses the return spring (25). When the key turns the lock back to the locked position the return spring pushes the locking pin back into the cutout, the ball bearing is pushed back into the detent by the thrust spring and the solenoid armature returns to its rest state, blocking the locking pin.

Many different materials may be used to fabricate this invention. The lock body, barrel, and locking pin are typically made of brass or steel. The springs are typically made of piano wire or other normally used spring wire. The ball bearing is commonly available. The solenoid may be custom made from a wound wire coil and metal armature or adapted from manufactured versions, particularly those made for cameras. The key may be brass or steel or other material.

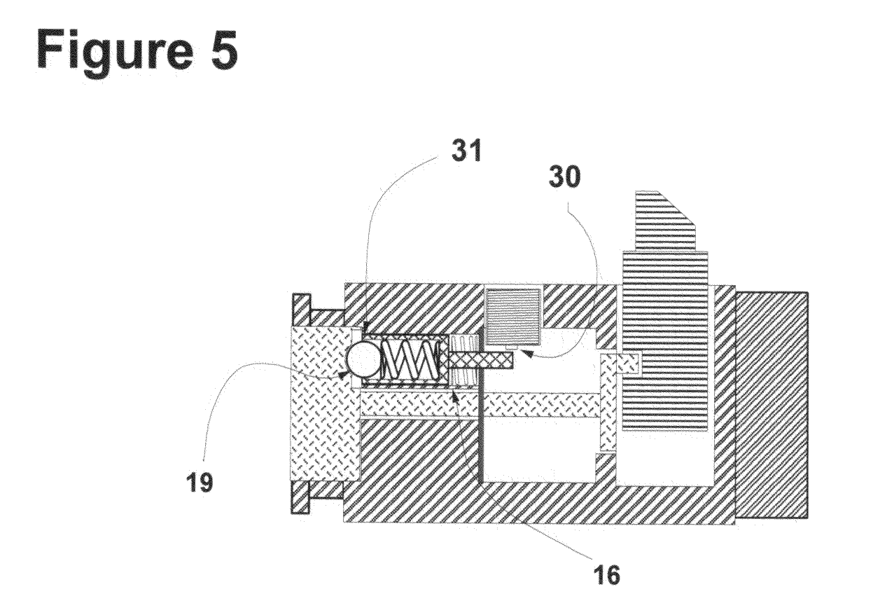

In another embodiment, the electro-mechanical device is a motor. A motor is much more efficient in the use of electrical power than a solenoid and does not have the initial inrush current requirement of a solenoid which may necessitate additional capacitors or other devices to handle this inrush load. The motor (34) is used to move a part to block or clear the locking pin movement. One version of this embodiment (FIG. 5) shows a weight (33) positioned at the end of the motor shaft by a spring (35) attached to the shaft. The motor shaft is positioned on the same axis as the locking pin inside the lock. At rest this weight blocks the locking pin preventing its rearward movement. When the motor spins, the centrifugal force pushes the weight to the side (36) allowing locking pin to move back. Compared to the mass of the lock, this weight is very small so that external inertia is unlikely to move it out of the way of the locking pin.

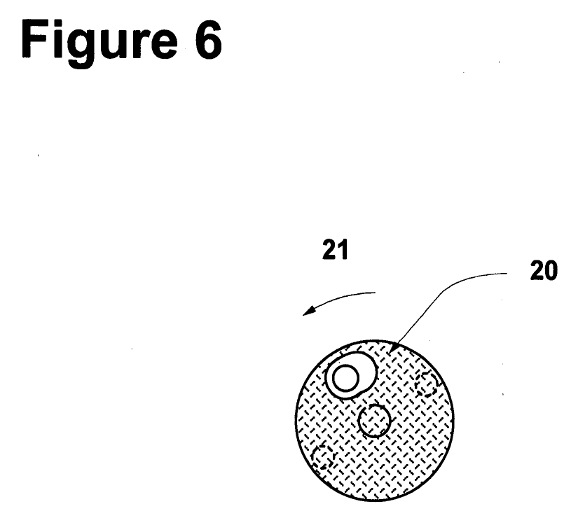

In another embodiment of the motor version (FIG. 6), two (2) blocking pins (41) are used in a chamber (37) drilled perpendicular to the motor shaft (38) in a cylinder (39) attached to the shaft. There is a bore (40) drilled into the chamber from the end of the cylinder opposite the motor (43) and in the same axis. The bore and motor shaft are aligned with the locking pin, the end of which is in the bore and close to the perpendicular pins in the chamber. Springs (42) hold the pins in the center of the chamber when the assembly is at rest (41). When the key turns the lock when the motor is not spinning the locking pin is blocked by the blocking pins and the lock remains locked. When the motor is spinning centrifugal force pushes the blocking pins toward the outside of the cylinder (44), compressing the springs (45) in the chamber. When the lock is turned while the motor is spinning the locking pin moves further into the bore since the blocking pins are no longer restricting rearward movement (43) allowing the lock to open. Since either or both blocking pins can block the bore and prevent the locking pin from moving back, no likely external inertia can move both blocking pins away from the center bore. The motor from a cell phone vibrating device may be used for this application. The motor is also immune from strong magnetic or electrical fields which may be used to try to defeat the mechanism.

In another embodiment the electro-mechanical device is a piezo device. This can be either a bending device, a motor, or other device which uses the ability of a piezo material to change an electrical charge into physical movement displacing the blocking mechanism.

In another embodiment the electro-mechanical device is a n ultrasonic device that uses sound waves to move the blocking mechanism.

In another embodiment the electro-mechanical device is a nitinol wire which changes shapes to block or unblock the locking pin either directly or by moving another part that acts as a block.

In another embodiment the electro-mechanical device is a pneumatic device that uses air or gas to move the blocking part.

In another embodiment the electro-mechanical device is an electrostatic device that moves the blocking part.

In another embodiment the electro-mechanical device is an electromagnet.

In another embodiment the electro-mechanical device is a MEMS device.

In another embodiment the electro-mechanical device is a electro-active fluid. Electrically changing the viscosity of the fluid will block or allow the locking pin to move by surrounding the pin with the fluid or used in a cylinder with the locking pin as a piston moving or not moving the fluid into another chamber or passage way based on the state of the viscosity.

In another embodiment the electro-mechanical device is a electro-active polymer. The foregoing description is intended primarily for purposes of illustration. This invention may be embodied in other forms or carried out in other ways without departing from the spirit or scope of the invention. Modifications and variations still falling within the spirit or scope of the invention will be readily apparent to those of skill in the art.

What is claimed:

1. An electronic lock comprising:
a body;
a barrel having a slot;
a pin disposed in said slot;
a blocking member disposed in said body to prevent movement of said pin;
an electro-mechanical device; and
activation of said electro-mechanical device causes said blocking member to be moved clear of said pin and movement of said barrel causes said pin to be moved out of said slot.

2. The electronic lock of claim 1 further comprising a first resilient member engaged with said pin and adapted to transfer movement of said barrel to said pin.

3. The electronic device of claim 3, further comprising a ball bearing adapted to transfer movement of said barrel to said first resilient member.

4. The electronic device of claim 3, wherein said barrel further comprises a ramp portion adapted to engage said ball bearing.

5. The electronic device of claim 4, wherein said ramp portion is disposed in said slot.

6. The electronic lock of claim 5, further comprising a second resilient member adapted to return said pin into said slot.

7. The electronic device of claim 6, wherein said first resilient member is a wire spring.

8. The electronic device of claim 7, wherein said second resilient member is a wire spring.

9. The electronic device of claim 8, wherein said electro-mechanical device is a solenoid.
